(19) United States
(12) Patent Application Publication
(10) Pub. No.: US 2016/0350798 A1
(43) Pub. Date: Dec. 1, 2016

(54) METHOD AND SYSTEM FOR MANAGING ACCESS TO ADVERTISEMENTS ON WEB PAGES

(71) Applicant: adResponse UG, Lobbach (DE)

(72) Inventor: Maciej Kornacki, Lobbach (DE)

(21) Appl. No.: 14/721,073

(22) Filed: May 26, 2015

(51) Int. Cl. G06Q 30/02; G06F 17/22; H04L 29/08

(52) U.S. Cl. CPC G06Q 30/0246; H04L 67/02; H04L 67/34; H04L 67/22; G06F 17/2247

(57) ABSTRACT

Disclosed is a method for providing a web page to a first terminal. The method comprising receiving at a first server a web page request from the first terminal and receiving at the first terminal the web page, a first executable code and a second executable code as a response to the web page request. The first executable code causes the first terminal to send a login information to a second server and the second executable code causes the first terminal to send a request for advertisement information to a third server. The method also comprises sending instructions from the second server to the first server to modify at least part of the web page, receiving at the first terminal the modified web page from the first server and the advertisement information from the third server and sending the received advertisement information to the second server.

### TECHNICAL FIELD

The present disclosure relates generally to web based advertising methods and systems; and more specifically, to methods and systems for managing access to advertisements on web pages.

### BACKGROUND

Advertisements are one of the primary sources of revenue for online publishers. Generally, online publishers display advertisements for products or services on their web pages while rendering content to consumers. During browsing, the consumer may access (e.g., view or click) these advertisements to gain information regarding the advertised products or services. As a result, the online publisher generates revenues from the advertisers using pay-per-view or pay-per-click methods.

However, the presence of these advertisements on the web pages has caused a bitter reading experience for the consumer. As a result, the consumers install advertisement blocking plug-in in a web browser application. The advertisement blocking plug-in is configured to monitor requesting and serving of advertisements for the web page. The advertisement blocking plug-in can block such request and prevent displaying of the advertisements on the web page. Consequently, the consumer can have no longer access to the advertisements and therefore the online publishers suffer loss of revenue.

Various prior art solutions exist to increase the revenues for the online publishers without causing trouble in the reading experience of the consumers. In an instance, the online publishers install payment networks on their respective web servers, which allow the consumers to view advertisement free web pages through paid subscriptions. Behaviour analysis of consumers indicates that the consumers are uncomfortable in paying for the web pages due to lack of interest and security concerns. As a result, the traffic on the websites of the online publishers has reduced considerably after shifting to revenue models obtained through paid subscriptions.

Therefore, in light of the foregoing discussion, there exists a need to provide a further method and system for managing access to advertisements on web pages without affecting the revenue of the online publishers.

### SUMMARY

The present disclosure seeks to provide a method and system for providing access to advertisement free web pages to the consumers and ensuring revenues for the online publishers through the advertisements.

In one aspect, an embodiment of the present disclosure provides a method for providing a web page to a first terminal. The method comprises the steps of:
a first server receiving a web page request from the first terminal;
the first terminal receiving the web page, a first executable code and a second executable code as a response to the web page request;
   the first executable code causing the first terminal to send a login information to a second server and the second executable code causing the first terminal to send a request for advertisement information to a third server;
the second server sending instructions to the first server to modify at least part of the web page;
the first terminal receiving the modified web page from the first server and the requested advertisement information from the third server; and
the first terminal sending the received advertisement information to the second server.

In another aspect, an embodiment of the present disclosure provides a system for providing web page content. The system comprises:
a first server configured to receive a web page request from a first terminal, wherein the first terminal is configured to receive the web page, a first executable code and a second executable code as a response to the web page request;
a second server configured to receive login information from the first terminal on processing of the first executable code; and
a third server configured to receive a request for advertisement information from the first terminal on execution of the second executable code,
   wherein the second server is configured to:
      send instructions to the first server to modify at least part of the web page; and
   the first terminal is configured to:
      receive the modified web page from the first server and the requested advertisement information from the third server, and
   send the received advertisement information to the second server.

Embodiments of the present disclosure substantially eliminate or at least partially address the aforementioned problems in the prior art, and efficiently manage the consumer's access to advertisements on the web pages.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system configured to provide a web page to a consumer, in accordance with an embodiment of the present disclosure;

FIG. 2 is a schematic illustration of steps of a prior art method for rendering advertisements embedded within the web page to the consumer;

FIG. 3 is a schematic illustration of steps of a prior art method for blocking advertisements embedded within the web page;

FIG. 4 is a schematic illustration of steps of a method for logging to an advertisement system, in accordance with an embodiment of the present disclosure;

FIG. 5 is a schematic illustration of steps of a method for providing access to the contents of the web page, in accordance with an embodiment of the present disclosure; and

FIG. 6 is a schematic illustration of steps of a method for providing access to contents of the web page using an Ad-Response emulator, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for providing a web page to a first terminal. The method comprises steps of:
a first server receiving a web page request from the first terminal;
the first terminal receiving the web page, a first executable code and a second executable code as a response to the web page request;
   the first executable code causing the first terminal to send a login information to a second server and the second executable code causing the first terminal to send a request for advertisement information to a third server;
the second server sending instructions to the first server to modify at least part of the web page;
the first terminal receiving the modified web page from the first server and the requested advertisement information from the third server; and
the first terminal sending the received advertisement information to the second server.

In another aspect, an embodiment of the present disclosure provides a system for providing web page content. The system comprises:
a first server configured to receive a web page request from a first terminal, wherein the first terminal is configured to receive the web page, a first executable code and a second executable code as a response to the web page request;
a second server configured to receive login information from the first terminal on processing of the first executable code; and
a third server configured to receive a request for advertisement information from the first terminal on execution of the second executable code,
   wherein the second server is configured to:
      send instructions to the first server to modify at least part of the web page; and
   the first terminal is configured to:
      receive the modified web page from the first server and the requested advertisement information from the third server, and
   send the received advertisement information to the second server.

In the present disclosure, the terms “advertisement” and “advertisement information” can be used interchangeably, i.e. when the term “advertisement” is used, it is to be understood as encompassing also “advertisement information”. An example of advertisement information is a pointer or a uniform resource locator (URL) to an image, video, text related to one or more products, services or brands to be advertised for a consumer or user. A further example of an advertisement information is an actual advertisement content such as an image, video, text, URL, coupon etc. Furthermore, the term “web” relates to Internet. The web can be accessed with multiple different ways including mobile communication devices, desktops, laptops etc. The web can be further accessed using browsing applications running in mobile or non mobile platforms as well as dedicated applications such as video viewers, advertisement applications running in mobile or non-mobile platforms.

The present disclosure relates to managing an access to the advertisements and content that can be shown to a consumer accessing the web pages. Generally, the online publisher provides space for advertisements at appropriate places in the web page. The online publisher can contact directly to an advertiser or through its own or any third party advertising platform (e.g., AD-sense platform) in order to automatically insert the advertisements at the places reserved within the web page. The present disclosure pertains to rendering web page to the consumer in such a way that the consumer can view the content without being disturbed by the advertisements which would have been shown to the consumer. The present disclosure also allows the consumer to view the advertisements at a later time and earn credit points for viewing the advertisements. The consumer can utilize the earned credit points in order to access the advertisement free content of the web page.

The system includes a first terminal, a second terminal, a publisher server, an advertisement server, and an advertisement response server (Ad-Response server) configured to render the advertisements and content associated with the web pages in accordance with one or more embodiment of the present disclosure. The one or more servers and the terminals can be configured to communicatively connect through a network. The one or more servers can be physically a single server or they can be arranged as a cloud service. The one or more servers can be operated by one or more parties. Further, the services (server application) related servers can be running in one or more physical servers or a server network. For example services related to the publisher server and the advertisement server could be run in a single server instance. The network can be a wired, wireless, or a combination thereof. Examples of such network includes, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

In an embodiment, the first and second terminals can be a computing device including but not limited to a desktop computer, laptop computer, handheld device, wireless device, console device, a mobile device, a tablet, or a similar computing device. The publisher server is a web server configured to publish web pages including content in a form of text, a document, an image, audio, video or multimedia or any other form of the information. In an embodiment, the publisher server is configured to embed advertisements at the appropriate places in the web page. Alternatively, the publisher server is configured to embed an executable code within the web pages such that the executable code when processed on a browser application of the first terminal causes the first terminal to initiate communication with the advertisement server to retrieve advertisements.

The advertisement server is configured to identify one or more advertisements that can be displayed to the consumer in the first or second terminals. The advertisement can be a graphical advertisement, a text advertisement, an audio advertisement, a video advertisement or any combination thereof. In an embodiment, the advertisement server is configured to identify advertisements contextually related to the content of the web page. In another embodiment, the advertisement server is configured to identify advertisements based on the attributes of the consumer or their terminals.

The present disclosure is configured to manage access to the advertisements or the content associated with the web page. During operation, the consumer places a request from the first terminal to access the web page from publisher server. On receiving the request, the publisher server is configured to send the web page, a first executable code and a second executable code as a response to the web page request to the first terminal.

The first executable code includes instructions to send login information of the consumer's account to the Ad-Response server in order to gain access to content associated with the web page. In an embodiment, the login information may include a consumer identification (ID) and a password, biometric login information or other login parameters. In an embodiment, the login can be made automatically without inputting the login information if the consumer has logged at least once with the first terminal. The Ad-Response server is configured to authenticate the consumer based on the login information. In an embodiment, the first executable code may initiate a consumer registration process with the Ad-Response server if the consumer is not registered with the Ad-Response server.

Once registered or signed in to the Ad-Response server, the Ad-Response server is configured to determine the eligibility of the consumer to access the content of the web page. In an embodiment, the Ad-Response server is configured to identify resources associated with the consumer's account and provide an access of the web page to the consumer on determining that the consumer has appropriate resources to access the web page. For example, the resources can be credit points associated with the account and the Ad-Response server is configured to compare the current credit points of the consumer's account with the threshold credit points which may be required to gain access to the content of the web page. If the consumer does not have required credit points in his account, the Ad-Response server can deny content access to the consumer. Alternatively the Ad-Response server could notify publisher server to lock the content from the consumer.

On determining that the consumer can be given access to the content of the web page, the Ad-Response server is configured to manage displaying of the advertisements associated with the web page. The Ad-Response server is configured to deliver instructions to the publisher server to modify at least a part of the web page. In an embodiment, the Ad-Response server is configured to deliver the instruction to publisher server to reduce a size of area allocated to the advertisements in the web page. Subsequently, the publisher server is configured to reduce the area allocated for the advertisement within the web page. For example, the publisher server may reduce the area allocated for each advertisement in the web page to one pixel.

Further, the first terminal is configured to receive the modified web page from the publisher server. As discussed above, the first terminal also receives the second executable code from the publisher server. The second executable code includes instructions for the first terminal to send a request for advertisements to the advertisement server. These are the advertisements which would have been shown in a regular size to the consumer when the advertisements are not blocked in the browser application of the first terminal.

On processing of the second executable code, the first terminal is configured to send request to the advertisement server to deliver advertisements. In an embodiment, the first terminal may send other information such as browsing history, consumer or terminal attributes, or cookies so as to enable the advertisement server to select one or more advertisements for the first terminal. The advertisement server is configured to select the advertisements and send these advertisements to the first terminal.

The present disclosure facilitates later viewing of the advertisements at the second terminal which are supposed to be viewed while the consumer accesses the content of the modified web page. In other words, the consumer is not required to view the advertisements while browsing the content associated with the modified web page. In an embodiment, the first terminal instead of the embedding the received advertisements within the modified web page sends the advertisements and/or related advertisement information to the Ad-Response server. The Ad-Response server is configured to store these advertisements and allow the consumer to access these advertisements for later viewing. Alternatively advertisement information can be received by Ad-Response server directly from the advertisement server.

In an embodiment, the present disclosure includes accessing the content associated with the modified web page in the first terminal and advertisements associated with the web page in the second terminal at a later time. For example, the consumer may access the stored advertisements using a mobile application installed in the second terminal. The consumer may enter the login information in the mobile application to gain access to the Ad-Response server. The Ad-Response server sends the stored advertisements to the second terminal and the consumer is able to view the stored advertisements after viewing the content at the first terminal

In another embodiment, the method includes accessing the modified web page in a first application in the first terminal, sending a request to the Ad-Response server to access the advertisement from a second application in the first terminal and accessing the advertisements with the second application. An example of first application is a web browser running in a mobile terminal (first terminal). The web browser would be blocking the advertisements in the example and sending information related to advertisements to the Ad-Response server. A second application such as a dedicated advertisement viewing application could be used in the same first terminal to access advertisement information (and advertisements or links to advertisements) from Ad-Response server in order to render advertisements to the consumer The first and second applications can include but not limited to an INTERNET EXPLORER™, MOZILLA FIREFOX™, OPERA™, or a similar browser application or applications such as games, dedicated viewers, video and audio players, or other application.

In a yet another embodiment, the method includes accessing the modified web page using a first uniform resource locator in a first application and sending a request to the second server to access the advertisement using a second uniform resource locator in the first application. For example, the consumer may access the INTERNET EXPLORER™ and enter a first URL (Uniform Resource Locator) for accessing the modified web page from a publisher's website. As discussed, the advertisements associated with this modified web page are sent to the Ad-Response server so that the consumer can enjoy viewing the content of the web page without advertisements. However, the consumer can enter another URL that can provide the consumer to access the advertisements in the same browser application.

In an embodiment, the method includes detecting usage of the advertisement in the second terminal and allocating resources to an account associated with the login information after the usage. Thus, the Ad-Response server includes a resource management module configured to manage resources associated with the consumer's account. For example, the resources can be in the form of monetary or credit points earned by the consumer while viewing the advertisements. If the consumer's account does not have sufficient amount of resources, the Ad-Response server is configured to allow the consumer to purchase the resources or earn credit points through advertisement viewing activities.

In an embodiment, the credit points are dependent on the type of the advertisement. For example, a text advertisement may have 3 credit points and a video advertisement may have 9 credit points. In an embodiment, the consumer may earn the credit points depending on the consumption of the advertisement. For example, the consumer may earn complete credit points associated with the video advertisement if the consumer has completely viewed the advertisement. Otherwise, the consumer may be given the credit points depending on the level of consumption of the video advertisement by the consumer.

The Ad-Response server is configured to include a content pricing module in order to manage the pricing associated with the content of the publisher's web site. The contents pricing module is configured to define an amount of resources (e.g., credit points) that the consumer may need to spend to gain access to the publisher's web page. In an embodiment, the amount of credit points required to access the content depend on the type of the content. For example, the consumer may need to spend a relatively higher credit points to access multimedia content than textual content. In an embodiment, the publisher may define the credit points that are required to access the content on the publisher's web site.

In an embodiment, the Ad-Response server enables the consumer to access the content from the publisher server. For example, the consumer may utilize his credit points to gain access to the content of web page from the first terminal. In alternate embodiment, the Ad-Response server is configured to allow the consumer to en-cash these credit points. As a result, the consumer can earn revenue while viewing the advertisements and remain motivated to view the advertisements.

In another embodiment, the Ad-Response server is configured to render one or more credit points into an account of the online publishers when the access the content from the first terminal. As a result, the online publishers can earn revenues not just from advertisements but also from additional credit points spent by the consumers for viewing the content on their respective web sites.

### DETAILED DESCRIPTION OF THE DRAWINGS

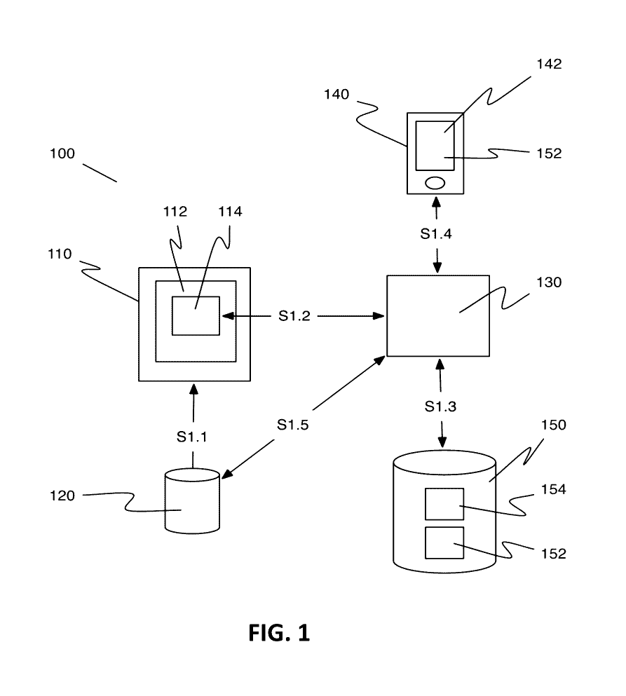

Referring now to the drawings, particularly by their reference numbers, FIG. 1 is schematic illustration of an advertisement system 100 configured to provide a web page to a consumer, in accordance with one or more embodiments of the present disclosure. The advertisement system 100 comprises a first terminal 110 configured to include a browser application 112 to gain access to content 114 received from a content publisher server 120 (first server). The advertisement system 100 further includes an Ad-Response server 130 (second server), a second terminal 140 and an advertisement server 150 (third server). The Ad-Response server 130 is configured to manage displaying of the content 114 at the first terminal 110 and advertising content 152 and 154 for the consumer at the second terminal 140. As illustrated in FIG. 1, the consumer can view the advertising content 152 in a browsing application 142 installed at the second terminal 140. The advertising content 152 includes one or more advertisements which would have been shown to the consumer when the consumer accessed the content 114 at the first terminal 110.

At step S1.1, the first terminal 110 is configured to receive the content 114 in the browser application 112 from the content publisher server 120 when the consumer makes a request to access the web page from the content publisher server 120. The consumer is prompted with a registration or a login screen when it is determined that an advertisement blocking plug-in is installed in the browser application 112.

At step S1.2, the consumer enters the registration details to create an account or login information to access his registered account at the Ad-Response server 130. Upon successful registration or authentication of the consumer, the Ad-Response server 130 is configured to access credit points associated with the consumer's account. The consumer is granted an access to the content 114 only if the consumer's account has sufficient credit points required to access the content 114. The Ad-Response server 130 is configured to facilitate access to the content 114 without the display of the advertisements which would have been shown to the consumer if the advertisement blocking plug-in has not been installed in the browser application 112 of the first terminal 110.

Therefore, at step S1.3, the Ad-Response server 130 instead of blocking the advertisements associated with the content 114, stores the advertisements as the advertising content 152 and advertising content 154 in the advertisement server 150.

At step S1.4, the consumer can logged into his account at the Ad-Response server 130 from the second terminal 140 for later viewing of these advertisements. As a result, the consumer enjoys advertisement free access to the content 114 at the first terminal 110 and the publisher is not devoid of revenues from the advertisements as the consumer can later view these advertisements (e.g., advertising content 152) at the second terminal 140. When the consumer has watched the advertising content 152, the Ad-Response server 130 is configured to add credit points in the consumer's account so that the consumer can use these credited points for further access to the publisher's content.

At step S1.5, the Ad-Response server 130 is configured to add credit points into an account of the publisher depending on the access pattern of the consumer on the publisher's web site and type of the content 114.

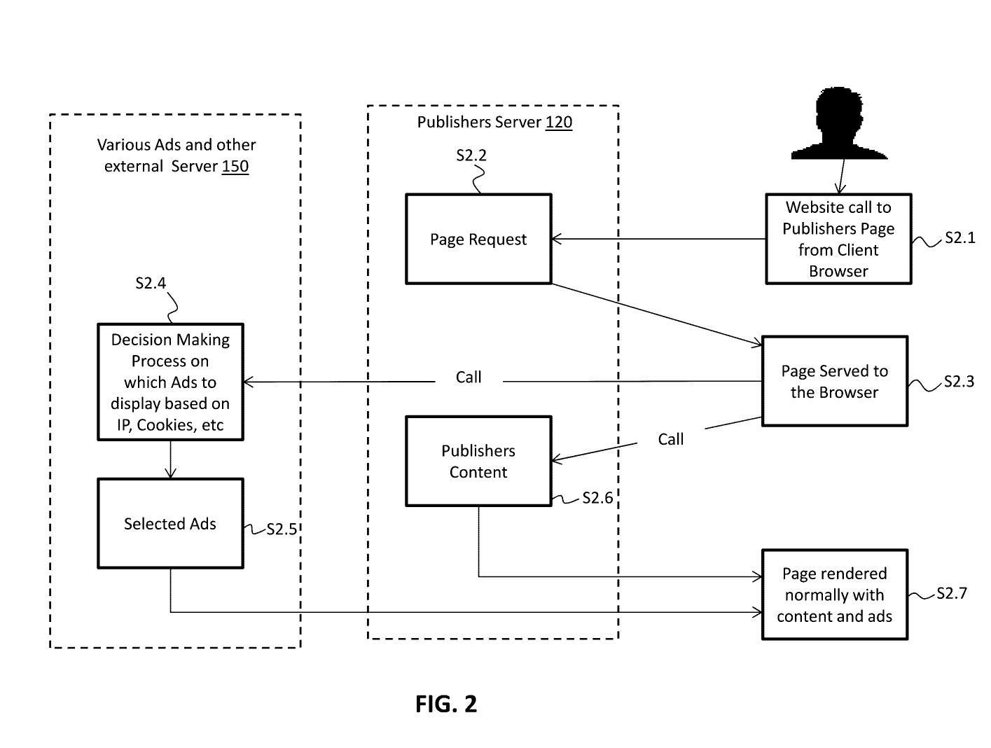

FIG. 2 is a schematic illustration of steps of a prior art method 200 for rendering advertisements embedded within the web page to the consumer, when an advertisement blocking plug-in is not installed in the browser application 112 of the first terminal 110. At step S2.1, the consumer initiates a call to access the web page from the browser application 112. At step S2.2, the content publisher server 120 receives the request and at step S2.3, the web page is served to the browser application 112. Generally, the content publisher server 120 embeds an executable code within the web page so that the browser application 112 transmits a request call for the advertisement to the advertisement server 150.

At step S2.4, the advertisement server 150 determines one or more advertisements based on the cookies or other attributes of the browser application 112.

At step S2.5, the advertisement server 150 selects the advertisements and transmits these advertisements to the first terminal 110.

At step S2.6, the content publisher server 120 forwards the content to the browser application 112. Since the browser application 112 is not installed with the advertisement blocking plug-in, at step S2.7, the browser application 112 displays the received advertisements along with the content of the web page.

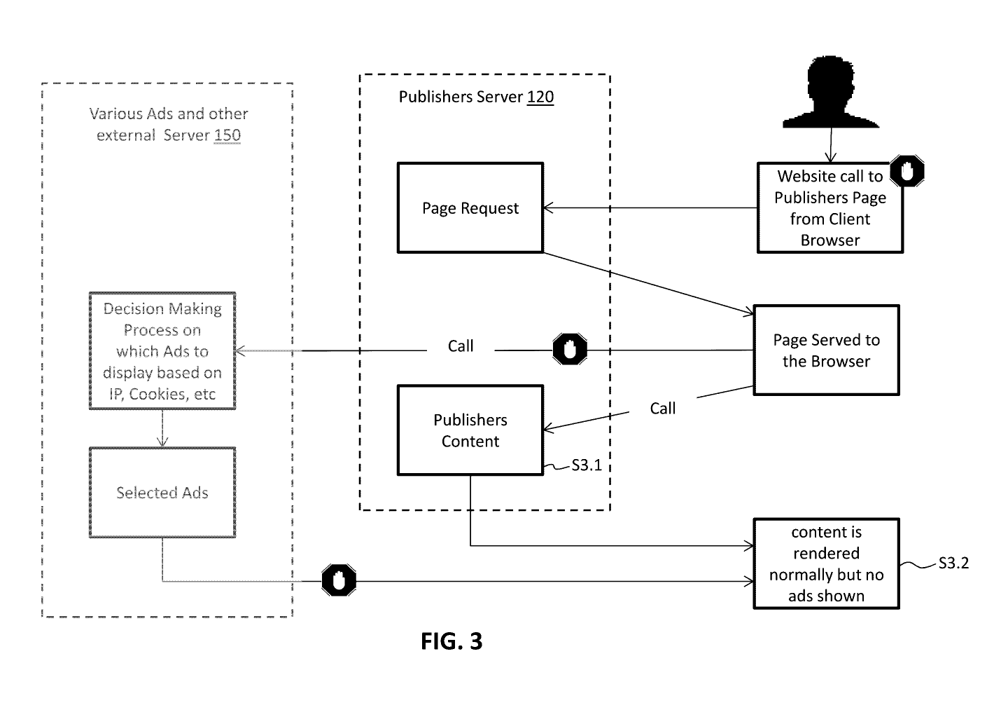

FIG. 3 is a schematic illustration of steps of a prior art method 300 for blocking advertisements embedded within the web page when an advertisement blocking plug-in is installed in the browser of the first terminal 110. The advertisement blocking plug-in is configured to block the advertisement or any request to receive advertisement from the advertisement server 150 when the consumer is accessing the web page in the browser application 112. At step S3.1, the browser application 112 calls to the content publisher server 120 to receive the content and at step S3.2, the browser application 112 renders the content of the web page to the consumer. Due to the presence of the advertisement blocking plug-in, the consumer views the area allocated for the advertisement in the web page as a blank area. Such blocking of the advertisements causes a considerable loss in revenues for the content publishers.

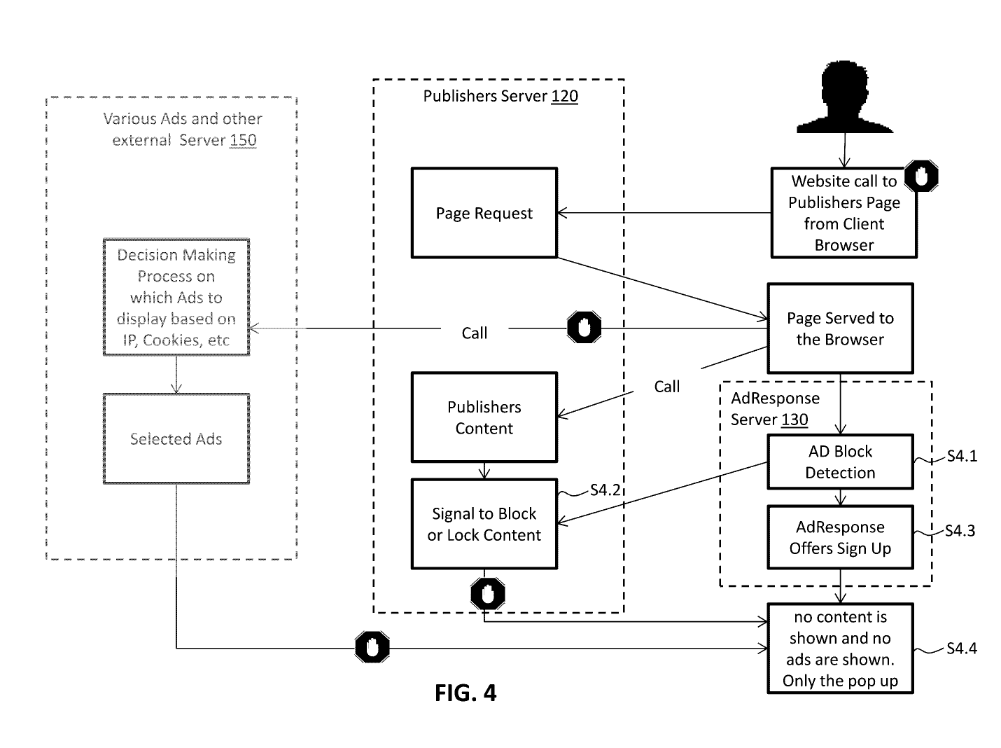

FIG. 4 is a schematic illustration of steps of method 400 for logging to an advertisement system 100 when an advertisement blocking plug-in is installed in the browser of the first terminal 110. As the web page is served to the browser application 112, a call to the Ad-Response server 130 is initiated. At step S4.1, the Ad-Response server 130 is configured to determine presence of the advertisement blocking plug-in within the browser application 112. At step S4.2, the Ad-Response server 130 is configured to send instructions to the content publisher server 120 to block the contents on finding that the advertisement blocking plug-in is installed within the browser application 112.

At step S4.3, the Ad-Response server 130 is configured to display an interface for the consumer to enter login details to access the Ad-Response server 130. If the consumer is new to the advertisement system 100 and does not have login information, the Ad-Response server 130 provides an interface for the consumer to register with the advertisement system 100. Thus, at step S4.4, the method 400 disables the display of the content of the web page and the advertisement unless the consumer logs in to the Ad-Response server 130.

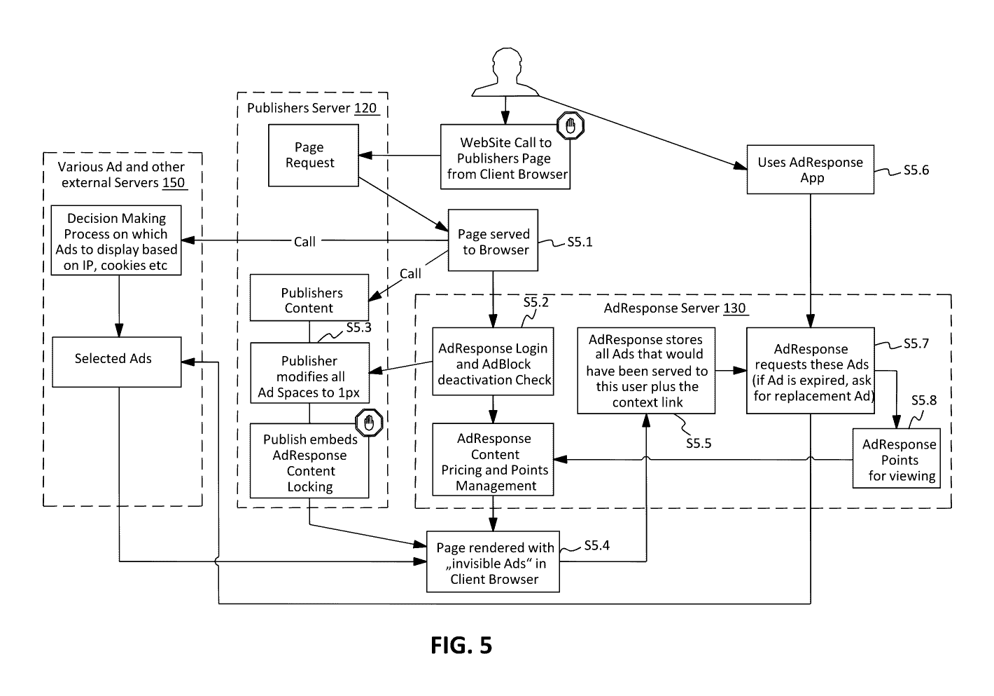

FIG. 5 is a schematic illustration of steps of method 500 for providing access to the contents of the web page, in accordance with an embodiment of the present disclosure. After successfully logging to the Ad-Response server 130, at step S5.1 the browser application 112 is configured to make a call to the content publisher server 120 for the content and to the advertisement server 150 for receiving the advertisements.

At step S5.2, the Ad-Response server 130 is configured to make a call to content publisher server 120 to modify the web page so as to reduce the area of the advertisements in the web page.

At step S5.3, the publisher server modifies spaces associated with the advertisements from the respective original areas to single pixel. At step S5.4, the Ad-Response server 130 is configured to render the modified page to the browser application 112. The modified web page includes invisible advertisements as the size allotted for the advertisements is very small and the consumer can-not view these advertisements in the modified web page.

At step S5.5, first terminal 110 is configured to send the advertisements which become invisible in the modified web page to the Ad-Response server 130 for later viewing of the consumer.

At step S5.6, the consumer accesses Ad-Response application from the second terminal 140 and logs in to the Ad-Response server 130 with the login information. At step S5.7, the Ad-Response server 130 is configured to display those advertisements to the consumer which were made invisible in the modified web page when the consumer accessed the content from the first terminal 110.

At step S5.8, an Ad-Response content pricing and points management module of the Ad-Response server 130 provides credit points in the account of the consumer for viewing the advertisements.

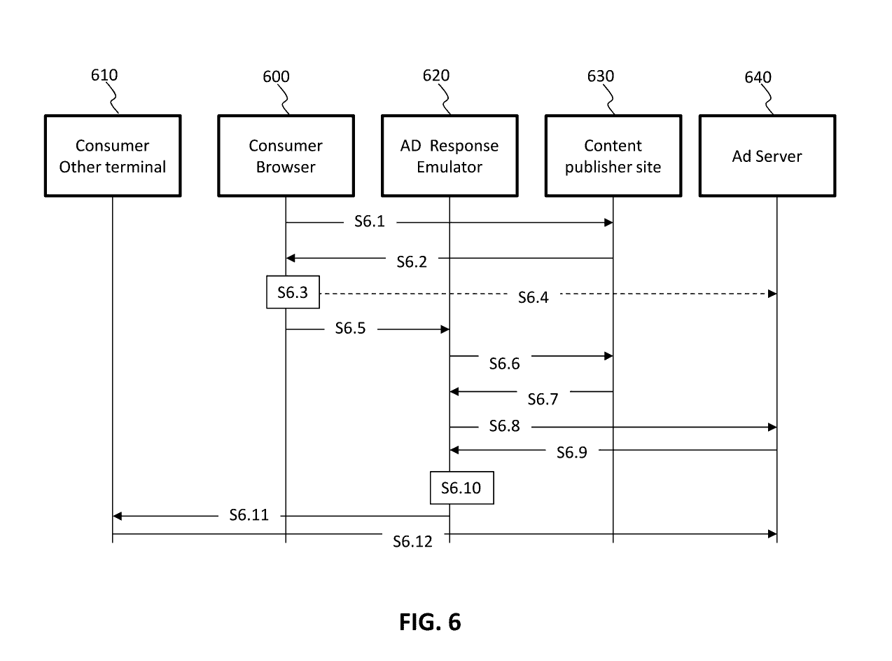

FIG. 6 is a schematic illustration of steps of method 600 for providing access to contents of the web page using an Ad-Response emulator 620, in accordance with an embodiment of the present disclosure. In an embodiment, the Ad-Response emulator 620 is configured to emulate or make real time access requests to a content publisher site 630 at synchronous to the consumer's request made from the consumer browser 600. The access requests to the content publisher site 630 would also generate a request to an advertisement server 640.

At step S6.1, the consumer browser 600 accesses the content publisher site 630 and at step S6.2, receives content for example in an HTML form. The HTML form may include a script causing the consumer browser 600 to request the advertisement server 640 to deliver advertisements.

At step S6.3, the advertisement blocking plug-in installed within the consumer browser 600 blocks a request to access to the advertisement server 640. As a result, a step S6.4 may not take place.

At step S6.5, the script in the HTML based content calls the Ad-Response emulator 620. Further, at step S6.6, the Ad-Response emulator 620 makes request to the content publisher site 630 to deliver content for the consumer. The request can emulate the request S6.1 by using same or similar parameters in the call.

At step S6.7, the Ad-Response emulator 620 receives HTML content and at step S6.8, the Ad-Response emulator 620 makes a request to the advertisement server (Ad server) 640 for advertisements. At step S6.9, the Ad-Response emulator 620 receives the advertisements and at step S6.10 the Ad-Response emulator 620 stores the advertisements for the consumer to be viewed from other terminal 610.

At step S6.11, the Ad-Response emulator 620 communicates to the other terminal 610 regarding availability of the advertisements. As the consumer accesses the advertisements in step S6.12, the advertisements are recorded to be consumed.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for providing a web page to a first terminal comprising steps of:
a first server receiving a web page request from the first terminal;
the first terminal receiving the web page, a first executable code and a second executable code as a response to the web page request;
the first executable code causing the first terminal to send a login information to a second server and the second executable code causing the first terminal to send a request for advertisement information to a third server;
the second server sending instructions to the first server to modify at least part of the web page;
the first terminal receiving the modified web page from the first server and the requested advertisement information from the third server; and
the first terminal sending the received advertisement information to the second server.

2. A method of a claim 1, wherein the modified web page is configured to reduce a size of area allocated to the advertisement information as compared to the web page.

3. A method of claim 1, wherein the method further comprising:
storing the advertisement information in the second server; and
sending the advertisement information to a second terminal.

4. A method of claim 3, wherein the method further comprising:
detecting usage of the advertisement information in the second terminal; and
allocating resources to an account associated with the login information after the usage.

5. A method of claim 4, wherein the resources are used to access content from the first server.

6. A method of claim 5, wherein the resources comprise a credit point value, wherein each type of the content has its own credit point value.

7. A method of claim 6, wherein the method further comprising:
rendering at least one credit point into an account of a publisher upon consumer's access to the content from the first terminal.

8. A method of claim 4, wherein the method further comprising:
determining value of the resources associated with the account; and
denying an access to the web page when the determined value is smaller than a threshold value required to access the web page.

9. A method of claim 1, wherein the method further comprising:
accessing the modified web page in a first application in the first terminal;
sending a request to the second server to access the advertisement information from a second application in the first terminal; and
accessing the advertisement information from the second application.

10. A method of claim 8, wherein at least one of the first and second applications is a web browser application.

11. A method claim 1, wherein the method further comprising:
accessing the modified web page using a first uniform resource locator in a first application; and
sending a request to the second server to access the advertisement information using a second uniform resource locator in the first application.

12. A second terminal for rendering advertisements received from a second server wherein the second server receives the advertisement information from a first terminal in accordance with the method of claim 1.

13. A system for providing web page content, the system comprising:
a first server configured to receive a web page request from a first terminal, wherein the first terminal is configured to receive the web page, a first executable code and a second executable code as a response to the web page request;
a second server configured to receive login information from the first terminal on processing of the first executable code; and
a third server configured to receive a request for advertisement information from the first terminal on execution of the second executable code;
wherein the second server is configured to:
send instructions to the first server to modify at least part of the web page; and
the first terminal is configured to:
receive the modified web page from the first server and the requested advertisement information from the third server, and
send the received advertisement information to the second server.

14. A system of a claim 13, wherein the modified web page is configured to reduce a size of area allocated to the advertisement information as compared to the web page.

15. A system of claim 13, wherein the second server is further configured to:
store the advertisement information in the second server; and
send the advertisement information to a second terminal.

16. A method of claim 15, wherein the second server is configured to:
detect usage of the advertisement information in the second terminal; and
allocate resources to an account associated with the login information after the usage.

17. A system of claim 16, wherein the resources are used to access content from the first server.

18. A system of claim 17, wherein the second server is configured to:
determine value of the resources associated with the account; and
denying an access to the web page when the determined value is smaller than a threshold value required to access the web page.

19. A system of claim 13, wherein the first terminal is further configured to:
provide an access to the modified web page in a first application in the first terminal;
send a request to the second server to access the advertisement information from a second application in the first terminal; and
provide an access to the advertisement information from the second application.

20. A method of claim 23, wherein the first terminal is further configured to:
provide an access to the modified web page using a first uniform resource locator in a first application; and
send a request to the second server to access the advertisement information using a second uniform resource locator in the first application.
